(19) United States
(12) Patent Application Publication
(10) Pub. No.: US 2015/0326831 A1
(43) Pub. Date: Nov. 12, 2015

(54) MANAGEMENT APPARATUS, A MANAGING METHOD, A STORAGE MEDIUM

(71) Applicant: CANON KABUSHIKI KAISHA, Tokyo (JP)

(72) Inventor: Tetsuhiro Funagi, Tokyo (JP)

(21) Appl. No.: 14/703,954

(22) Filed: May 5, 2015

(30) Foreign Application Priority Data
May 8, 2014 (JP) 2014-097113

(51) Int. Cl. H04N 7/18

(52) U.S. Cl. CPC H04N 7/181

(57) ABSTRACT

A management apparatus managing a plurality of network cameras receives, via a communication network, video shot by a plurality of network cameras, and controls to display, in accordance with information representing network cameras which shoot video to be displayed in accordance with a plurality of display layouts, information based on a number of times the video shot by the network cameras are displayed or a time of period for which the video shot by the network cameras are displayed.

### BACKGROUND OF THE INVENTION

1. Field of the Invention

The present invention relates to a management apparatus that manages a plurality of network cameras and a managing method.

2. Description of the Related Art

In an image monitor system that displays images from a plurality of network cameras, the monitor screen is conventionally split into parts to display a plurality of images simultaneously. For example, Japanese Patent Laid-Open No. 10-234032 discloses a display apparatus that displays images from a plurality of cameras on a split monitor screen. Also, U.S. Patent Application Publication No. 2006-0268330 discloses an image reproduction apparatus that can set the placement of images on a split screen and the recording times of images displayed.

In general, allocation of images from such network cameras to a split screen is set manually by the user. When the user sets the allocation manually, the user has to manage network cameras that are not allocated to the split screen and network cameras that are allocated to the split screen even if a large number of network cameras are used.

This requires effort on the part of the user, and also there arise problems such as that there is a network camera whose image is not displayed due to mismanagement by the user.

### SUMMARY OF THE INVENTION

An object of the present invention is facilitating management of a plurality of network cameras when images from the network cameras are displayed.

According to an aspect of the invention, there is provided a management apparatus which comprises: a receiving unit configured to receive, via a communication network, images shot by a plurality of network cameras; and a control unit configured to control to display, in accordance with first information representing network cameras to be managed and second information representing network cameras which shoot images to be displayed on a display unit, third information of at least one managed network camera which is not included in the network cameras represented by the second information.

According to another aspect of the invention, there is provided a management apparatus which comprises: a receiving unit configured to receive, via a communication network, video shot by a plurality of network cameras; and a control unit configured to control to display, in accordance with information representing network cameras which shoot video to be displayed in accordance with a plurality of display layouts, information based on a number of times the video shot by the network cameras are displayed or a time of period for which the video shot by the network cameras are displayed.

Further features of the present invention will become apparent from the following description of exemplary embodiments with reference to the attached drawings.

### BRIEF DESCRIPTION OF THE DRAWINGS

FIG. 1 is a view showing a configuration of a system.

FIG. 2 is a view showing a configuration of a network camera.

FIG. 3 is a view showing a configuration of an image reproduction apparatus.

FIG. 4 is a view showing an example of layout information.

FIG. 5 is a view showing an example of display by an image display unit.

FIG. 6 is a view showing an example of network camera information.

FIG. 7 is a view showing an example of list information of layout information.

FIGS. 8A and 8B are flowcharts showing an example of layout aggregation processing.

FIG. 9 is a view showing an example of layout information of layout sequence (layout auto switch).

FIG. 10 is a flowchart showing an example of layout aggregation processing of layout sequence.

FIG. 11 is a view showing an example of layout information.

FIG. 12 is a flowchart showing an example of layout sequence setting updating processing.

FIG. 13 is a flowchart showing an example of layout sequence setting updating processing.

### DESCRIPTION OF THE EMBODIMENTS

Preferred embodiments of the present invention will be described hereinafter with reference to the accompanying drawings.

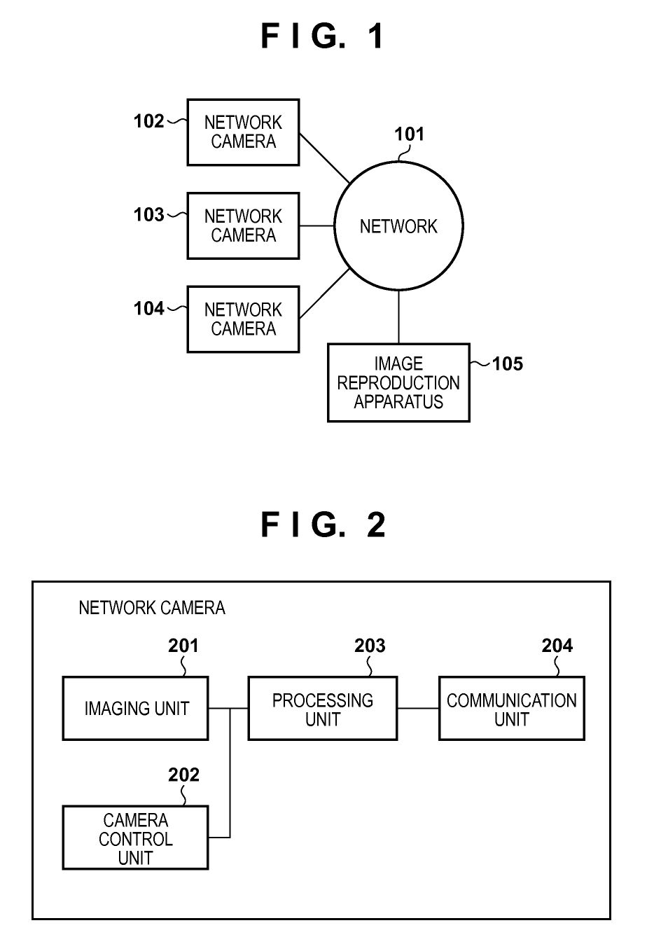

FIG. 1 is an example of a configuration of a system according to an embodiment of the invention. The system is constituted by at least one network camera 102 to 104 that delivers an image to a network, an image reproduction apparatus 105, and a network 101 connecting these apparatuses. The image reproduction apparatus 105 functions as a management apparatus that manages images from network cameras to perform display control. The numbers of the network cameras 102 to 104 and the image reproduction apparatus 105 are not limited to specific numbers: they may be larger than those shown in FIG. 1.

The network cameras 102 to 104 are apparatuses capable of generating time-series electronic data such as images and transmitting generated data. Also, the network cameras 102 to 104 may be apparatuses that transmit voice data other than images and time-series data from a sensor such as a thermometer. An example use of the system of this embodiment is monitoring work. In this case, the image reproduction apparatus receives images from several tens to several thousands of network cameras and displays received images simultaneously.

The first embodiment will be described hereinafter with reference to FIGS. 2 to 8.

FIG. 2 shows an example of the configuration of the network camera 102 shown in FIG. 1. The network cameras 103 and 104 also have similar configurations. An imaging unit 201 shoots an image. The imaging unit 201 may include a mechanism of a pan head for changing the shooting direction, a mechanism of changing the settings of shooting such as the zoom, focus, and diaphragm, a processing mechanism of masking and time superimposition for the image, and a mechanism of image processing of changing the brightness and tone. A camera control unit 202 receives a control command from a processing unit 203 and controls the imaging unit 201 according to the control command.

The processing unit 203 analyzes a request command received from outside via a communication unit 204 and executes processing according to the analysis result. When receiving a request command of controlling the camera, for example, the processing unit 203 converts this to a control command and sends the command to the camera control unit 202 to make the camera control unit 202 execute the control. Also, the processing unit 203 converts the execution result of the request command to a response style and sends back the response to outside via the communication unit 204, for example. The communication unit 204 performs control on communication with other apparatuses.

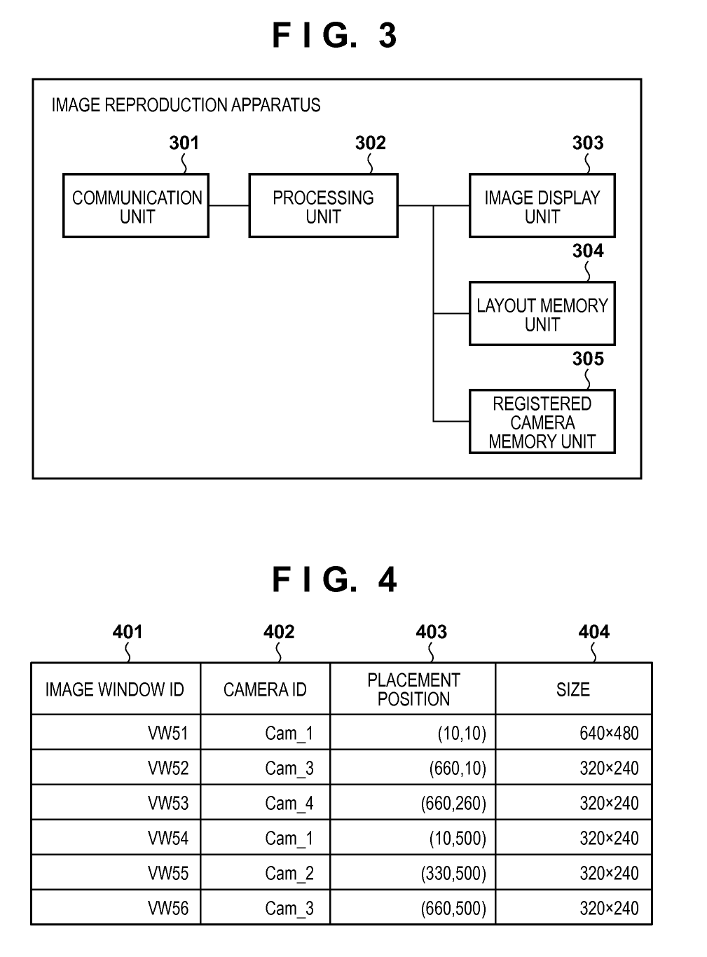

FIG. 3 shows an example of the configuration of the image reproduction apparatus 105 according to this embodiment. A communication unit 301 performs control on communication with other apparatuses. A processing unit 302 performs management of the entire recording apparatus (camera) and computation processing. The processing unit 302 is implemented by a central processing unit (CPU), etc. An image display unit 303 displays a graphical user interface (GUI), an image, etc. on an apparatus such as a monitor and a display.

A layout memory unit 304 stores placement layout information including the display position and size of each of a plurality of images when the images are displayed on the image display unit 303. The image reproduction apparatus 105 manages the placement layout by storing it in the layout memory unit 304. In the placement layout, the positions of a plurality of regions placed in a display area are associated with information that identifies network cameras configured to present images to the respective regions.

A registered camera memory unit 305 stores information on a plurality of network cameras registered previously so that the image reproduction apparatus can acquire images from a plurality of network cameras. The layout memory unit 304 and the registered camera memory unit 305 are constituted by a hard disk, an optical disk, a memory card, etc.

When the user selects a layout via the GUI, the processing unit 302 generates a layout ID that is identification information specifying the selected layout. The processing unit 302 then acquires layout information corresponding to the generated layout ID from the layout memory unit 304, analyzes the acquired layout information, and generates camera IDs that are identification information specifying network cameras placed according to the layout.

Thereafter, the processing unit 302 acquires access destinations to the specified network cameras from the registered camera memory unit 305 based on the generated camera IDs, generates image acquisition commands to the network cameras, and transmits the commands, to acquire images. The processing unit 302 places and scales the presented images in accordance with the placement in the layout information, and controls the image display unit 303 to display the images.

FIG. 4 is a table representing an example of layout information stored in the layout memory unit 304. The layout information is comprised of information on a plurality of image windows where images are reproduced. The layout information includes an image window ID 401 for uniquely specifying the image window information, a camera ID 402 that specifies a network camera corresponding to each image window, a placement position 403 of the image window in the display area, and size information 404 in the display area. The layout information can also include an item of information other than those shown in FIG. 4. For example, a shooting condition may be included as will be described later.

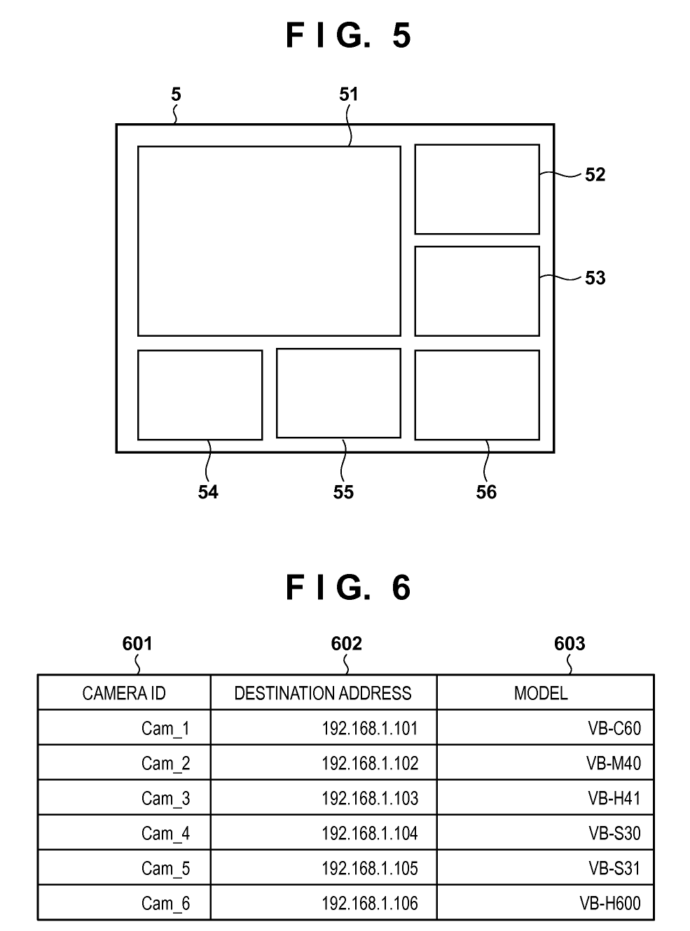

FIG. 5 is an example of the display of the image display unit 303 corresponding to the layout information shown in FIG. 4. In FIG. 5, the entire display area is split into six image regions 51 to 56. The image regions 51 to 56 respectively correspond to the image window information of the image window IDs VW51 to VW56 in FIG. 4. The number of image windows included in the layout information in FIG. 4 changes with the number of image windows displayed by the image display unit 303.

The images in the plurality of image windows displayed by the image display unit 303 are not necessarily different from one another, but an image from one network camera may be displayed on a plurality of different image windows.

FIG. 6 is an example of a table representing network camera information stored in the registered camera memory unit 305. The network camera information is information on the network cameras constituting the system according to this embodiment.

The network camera information includes a camera ID 601 for uniquely specifying a network camera, a destination address 602, such as a host name and an IP address, to which connection is made for image acquisition, etc., and model information 603 indicating the model of the network camera. The network camera information can also include an item of information other than those shown in FIG. 6.

In this embodiment, a plurality of pieces of layout information (FIG. 4) can be stored in the layout memory unit 304. In this embodiment, also, by selecting one of the plurality of pieces of layout information stored in the layout memory unit 304, images can be displayed on the image display unit 303 in the layout according to the selected layout information. In this embodiment, a table representing a list of such a plurality of pieces of layout information is stored in the layout memory unit 304.

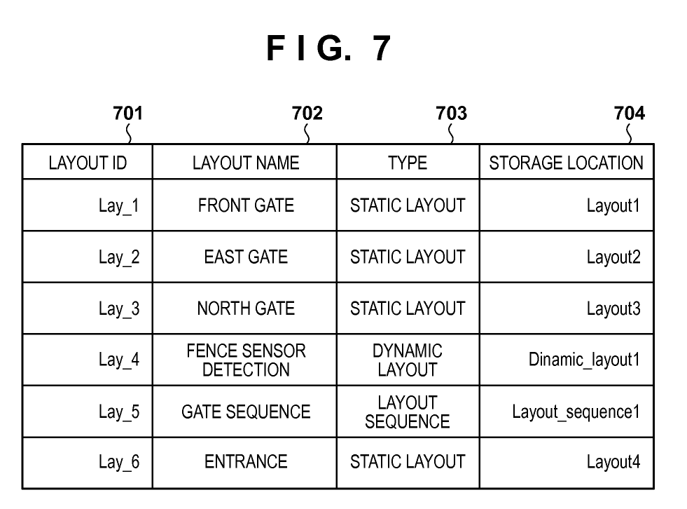

FIG. 7 is an example of a table representing a list of a plurality of pieces of layout information. The list includes, for each piece of layout information stored, a layout ID 701 that is identification information for uniquely specifying the layout information, a layout name 702 that is the name of the layout, a type 703 of the layout, and a storage location 704 where the layout information is stored.

The layout name 702 can be a name with which the user can distinguish the configuration of the layout from others when the name is displayed on the GUI. The type 703 of the layout is any of static layout, dynamic layout, and layout sequence in this embodiment. The static layout is a layout shown in FIGS. 4 and 5. The layout sequence will be described later. The dynamic layout is not covered in this embodiment, and thus description is omitted.

The storage location 704 is information, such as a file name and address information on a memory, used when layout information in the layout memory unit 304 is read. The list of layout information can also include an item of information other than those shown in FIG. 7. For example, information on whether or not the layout information is being selected by the user may be included in the list for each piece of layout information.

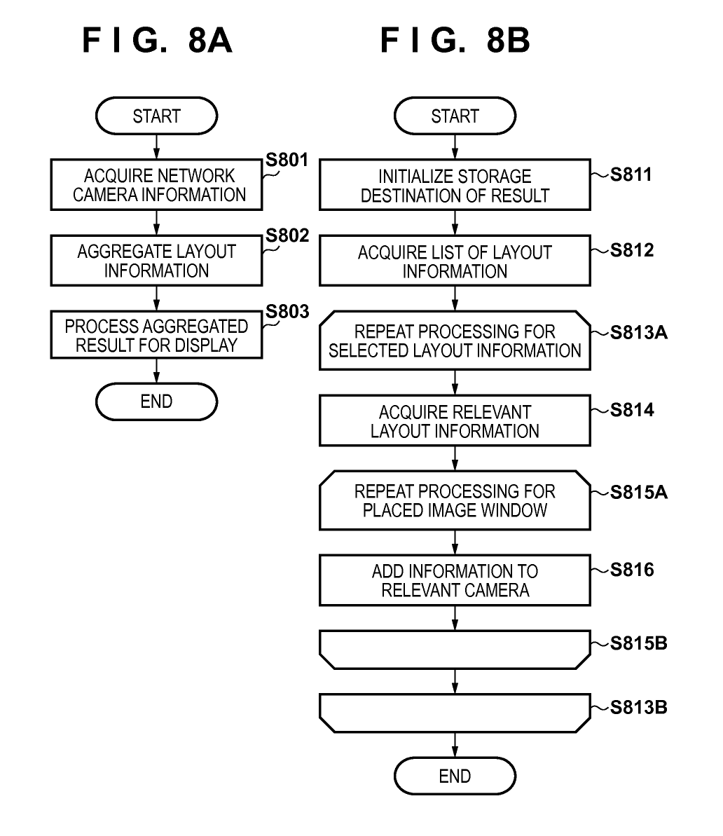

FIGS. 8A and 8B are flowcharts showing an example of processing performed by the processing unit 302 for outputting the result of aggregation of the layout information. FIG. 8A shows the entire processing by the processing unit 302.

The flow shown in FIG. 8A is started with an operation by the user performed via the GUI of the image display unit 303. The processing unit 302 acquires network camera information (FIG. 6) stored in the registered camera memory unit 305 (S801). The processing unit 302 then executes aggregation, following the processing described later with reference to FIG. 8B, using the network camera information acquired in S801 and the layout information stored in the layout memory unit 304 (S802). In the illustrated example, the layout information registered in the table in FIG. 7 is aggregated.

The processing unit 302 then performs processing for display for the user based on the aggregated result in S802 (S803).

FIG. 8B is a flowchart showing an example of the aggregation processing S802 of layout information in the flowchart in FIG. 8A.

First, for storing interim information for the aggregated result used in S803 in FIG. 8A and the final result, the processing unit 302 adds a storage destination where the number of times of display can be accumulated in correspondence with each of the network camera IDs in the network camera information (FIG. 6) acquired in S801. The processing unit 302 assigns 0 as the initial value of the number of times of display in the storage destination (S811). That is, the number of times of display for each of the plurality of network cameras constituting the system according to this embodiment is set to 0 as the initial value.

Subsequently, the processing unit 302 acquires the list of layout information (FIG. 7) from the layout memory unit 304 (S812). When detecting that one or more layouts have been selected by the operation of the user, the processing unit 302 repeats processing between S813A and S813B for the selected layouts. When detecting that all the layouts have been selected by the user, or detecting that no special designation has been made by the user, the processing unit 302 repeats the processing between S813A and S813B for all the layouts.

The processing unit 302 determines a target layout from the selected layouts or from all the layouts. The processing unit 302 then acquires layout information (FIG. 4) from the storage location 704 corresponding to the layout ID specifying the determined layout in the list of layout information (FIG. 7) (S814).

The processing unit 302 repeats processing in S816 for each of the image windows included in the acquired layout information (S815A and S815B). That is, first, the processing unit 302 specifies the network camera allocated to each image window based on the camera ID 402. The processing unit 302 then increments by 1 the value of the number of times of display corresponding to the camera ID of the specified network camera (S816).

By the processing in this flowchart, the number of times of placement of the network camera (the number of times by which the network camera presents an image/picture) is accumulated for the layouts selected by the user or for all the layouts. By this processing, also, the processing unit 302 can determine which network cameras present their images on the display regions. In the processing in S803 in FIG. 8A that is processing subsequent to FIG. 8B, a list of network cameras where the value of the number of times of display is 0 may be displayed by the image display unit 303, for example. With this, the user can recognize network cameras that have not yet been placed in the layouts.

Alternatively, whether or not each of the network cameras managed by the image reproduction apparatus 105 is used for display on any image window may be determined based on the camera ID in the layout information. That is, it is unnecessary to count on how many image windows each of the network cameras is displayed.

The display form for the user in the processing in S803 is not limited to a specific form, but any other display form may be used as long as the user can check the situation of presentation of images from a plurality of network cameras.

According to this embodiment, network cameras that have not been placed in an existing layout or a plurality of layouts selected by the user can be displayed as a list. Thus, when the user desires to display images from the registered network cameras at least once using a plurality of layouts, for example, the user can be easily informed of a network camera that has not yet been placed in the layouts, and thus can easily perform the work of setting layouts.

Also, in the processing in S803 in FIG. 8A, by displaying the number of times of display for each network camera as it is, the user can be informed of a network camera that is placed redundantly. Thus, in this embodiment, it is possible to assist the user to recognize a mistake such as one related to a network camera that has been unintentionally placed in a layout by the user.

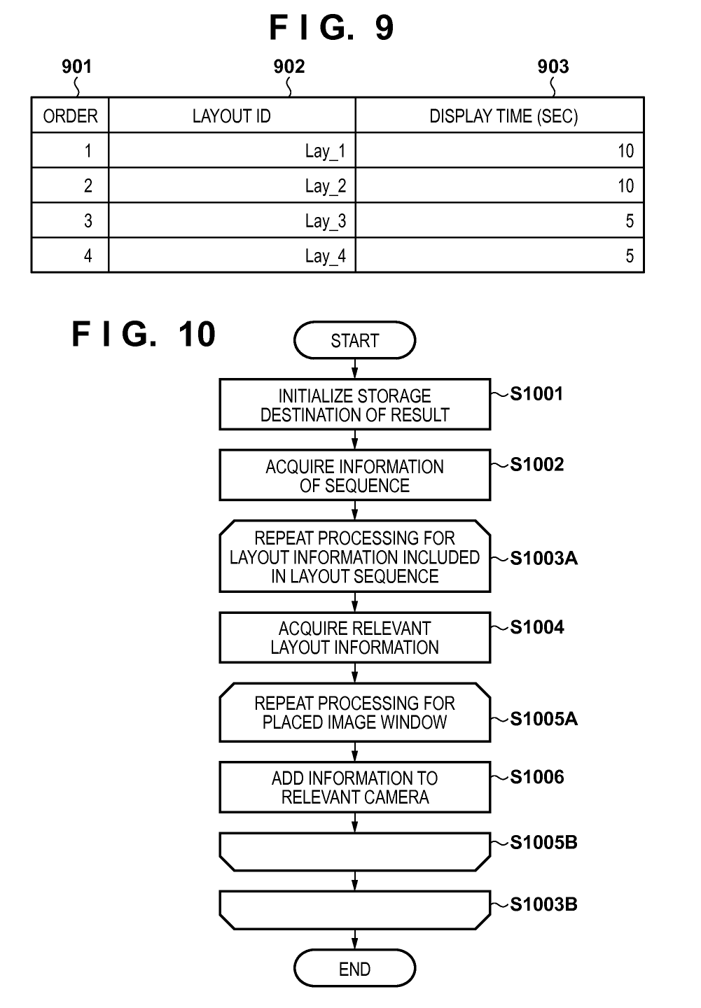

An operation performed when the type of the layout is layout sequence (layout auto switch) will be described hereinafter with reference to FIGS. 9 and 10. FIG. 9 is a table representing an example of a configuration of layout information of which the layout type is layout sequence. The layout information of layout sequence includes an order 901 in which pieces of layout information are switched and displayed based on a predetermined pattern, a layout ID 902 that is identification information uniquely specifying the layout, and a display time 903 that is the period of time for which display is continued. The list of layout information can also include an item of information other than those shown in FIG. 10.

FIG. 10 is a flowchart showing an example of aggregation processing of layout information according to this embodiment. In S802 in FIG. 8A, when the type of the selected layout is layout sequence, the processing in FIG. 10 is executed, in place of the processing in FIG. 8B.

First, for storing interim information of the aggregated result and the final result, the processing unit 302 adds three storage destinations, i.e., a storage destination where the number of times of display can be accumulated, a storage destination where the display time can be accumulated, and a storage destination where the product of the display area and the display time can be accumulated, in correspondence with each of the network cameras in the network camera information (FIG. 6) acquired in S801. The processing unit 302 assigns 0 as the initial values of the number of times of display, the display time, and the product of the display area and the display time in these storage destinations (S1001). The processing unit 302 acquires the layout information of layout sequence (FIG. 9) from the layout memory unit 304 (S1002).

The processing unit 302 analyzes the layout information of layout sequence acquired, and repeats processing between S1003A and S1003B for the layouts constituting the layout sequence.

The processing unit 302 acquires the display time 903 corresponding to the layout ID 902 that specifies a target one of the plurality of layouts included in the target layout sequence from the layout information of layout sequence (FIG. 9). For example, 10 seconds as the display time of the layout ID of Lay_1 is acquired. Also, the processing unit 302 acquires the layout information (FIG. 4) from the storage location 704 corresponding to the layout ID 701 in the list of layout information (FIG. 7) and analyzes the information (S1004). For example, the layout information of the layout ID of Lay_1 is acquired from the storage location 704 of the layout information of the layout ID of Lay_1.

The processing unit 302 repeats processing in S1006 (S1005A and S1005B) for each of the image windows included in the acquired layout information (FIG. 4). That is, the processing unit 302 specifies the network camera allocated to each image window based on the camera ID 402. The processing unit 302 then updates the number of times of display, the display time, and the product of the display area and the display time corresponding to the camera ID of the specified network camera. More specifically, the processing unit 302 increments the value of the number of times of display by 1, adds the display time acquired in S1004 to the display time, and adds the product of the display size and the display time acquired in S1004 to the product of the display area and the display time (S1006).

In other words, the processing unit 302 increments the number of times of display by 1 and increases the display time by 10 seconds for each of the cameras corresponding to the image windows included in the layout information of the layout ID of Lay_1, e.g., the image window IDs of VW51 to VW56. Also, the processing unit 302 adds the product of the display size of each of the image window IDs of VW51 to VW56 and the display time of 10 seconds to the product of the display area and the display time of each of the cameras corresponding to the image window IDs of VW51 to VW56.

According to this embodiment, the user can acquire the number of times of display for each network camera in one round of layout sequence. Also, the user can acquire the display time for each network camera displayed in one round of layout sequence. Moreover, the user can acquire the product of the display area and the display time for each network camera displayed in one round of layout sequence. By this acquisition, the user can check the use situation of the plurality of network cameras in more detail.

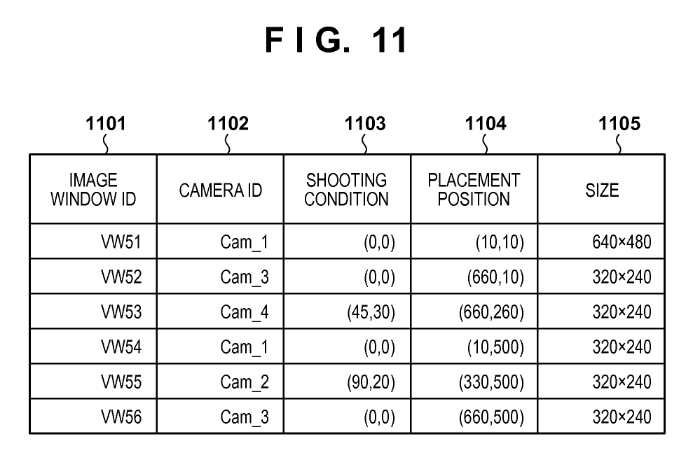

Also, as shown in FIG. 11, a shooting condition may be included in the layout information. FIG. 11 is a table representing an example of layout information according to this embodiment stored in the layout memory unit 304. This layout information is different from the layout information shown in FIG. 4 in that a shooting condition 1103 is included as information associated with each image window. Examples of the shooting condition include the shooting method under pan head control with the network cameras, the angle of view with a zoom mechanism, and focusing with an imaging mechanism. In FIG. 11, the pan position and the tilt position are designated under pan head control as an example of the shooting condition 1103.

In the specification of network cameras and the accumulation of the results (S813A to S813B) in the flowchart in FIG. 8B, the processing unit 302 aggregates the number of times of display for each shooting condition in this embodiment.

That is, first, when incrementing the number of times of display corresponding to a given camera ID by 1, the processing unit 302 stores the number in the storage destination in combination with the shooting condition. Thereafter, in incrementing the number of times of display corresponding to the same camera ID by 1, the processing unit 302 increments the number by 1 if the shooting condition is the same as that previously stored. However, if the shooting condition is different from that previously stored, the processing unit 302 newly stores 1 as the number of times of display in the storage destination in combination with this shooting condition. Note that, as in the second embodiment, the display time, etc. may be aggregated for the layout sequence.

According to this embodiment, the user can acquire the number of times of display for each network camera for each shooting condition. Therefore, the user can check, in more detail, under which shooting condition the plurality of network cameras are being used as the use situation thereof.

The information of the layout sequence may be updated using the aggregated result of the layout information.

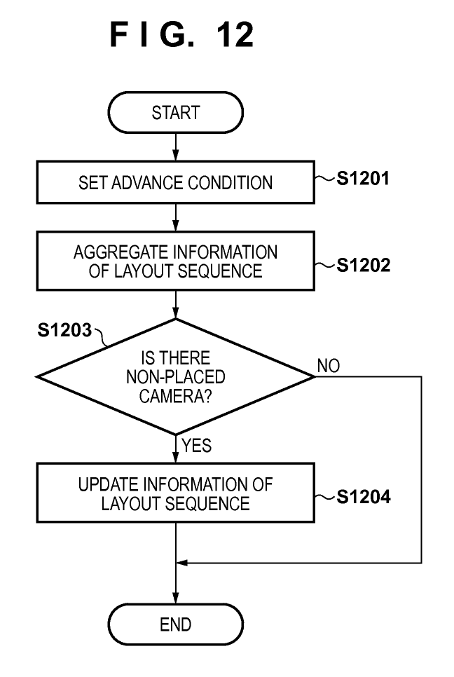

FIG. 12 is a flowchart showing an example of processing for updating the setting of the layout sequence. When the user sets a condition using the GUI of the image display unit 303, the processing unit 302 reads the set condition (S1201). Examples of the set condition include the existing layout sequence to be analyzed and updated, the maximum number of image windows placed on the screen when a new layout is added, the display time of the new layout, a list of a plurality of network cameras to be aggregated, etc.

The processing unit 302 aggregates the layout information in the layout sequence by a method such as the method described above with reference to FIG. 10 (S1202). That is, the processing unit 302 aggregates the number of times of display of each of the pieces of layout information constituting the specified layout sequence from the list of network cameras to be aggregated set in S1201. The processing unit 302 determines whether there is a network camera for which the number of times of display is 0 from the output result of S1202 (S1203), and outputs a list of such network cameras.

If there is a network camera for which the number of times of display is 0 (YES in S1203), the processing unit 302 updates the information of the layout sequence by performing processing described below (S1204).

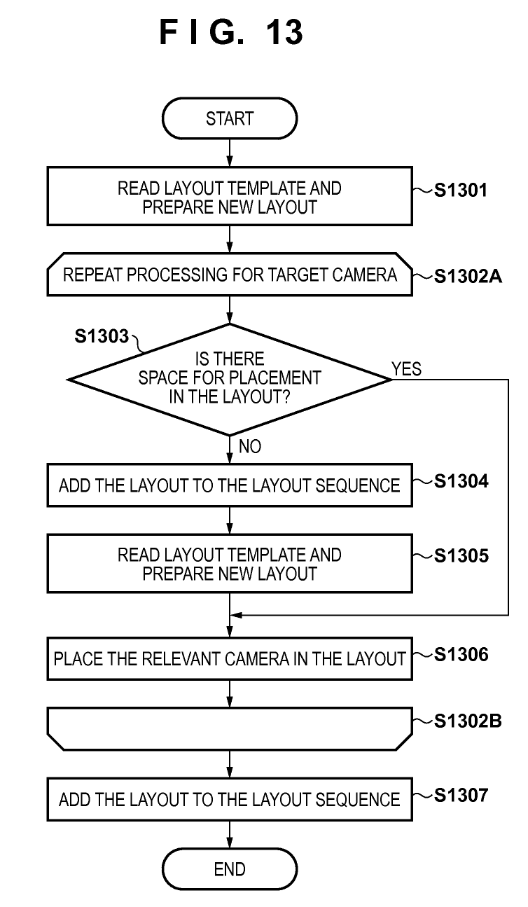

FIG. 13 is a flowchart showing an example of the processing in S1204 that updates the information of the layout sequence in the flowchart in FIG. 12. The processing unit 302 reads a layout template stored in the layout memory unit 304 based on the maximum number of image windows set in S1201 and the number of network cameras for which the number of times of display is 0 in the list output in S1203. The processing unit 302 prepares a new layout from the read template and sets this layout as the layout at the placement destination (S1301).

An example of the layout template is one where the values of the camera ID 402 in the table of layout information in FIG. 4 are blank and layout information can be prepared by entering values of the camera ID 402. Layout templates have been prepared previously according to the number of image windows placed, and stored in the layout memory unit 304. The layout templates may be prepared according to the number of image windows, or prepared for only typical placement.

The layout template read in S1301 may be one according to the maximum number of image windows set in S1201 or one according to the number of network cameras for which the number of times of display is 0 in the list output in S1203. The smaller one of the above two numbers may be used. Otherwise, a layout template permitting placement of a number of image windows larger than either of these two numbers may be selected and read.

The processing unit 302 executes subsequent processing steps S1303 to S1306 repeatedly for each network camera in the list of network cameras for which the number of times of display is 0 output in S1203 (S1302). The processing unit 302 determines whether there is a space for placement of an image from the target network camera in the list of network cameras in the layout at the placement destination (S1303).

If there is no space for placement (NO in S1303), the processing unit 302 adds the layout to the layout sequence to be updated in association with the layout information already placed and the display time set in S1201 (S1304). The processing unit 302 reads a layout template stored in the layout memory unit 304 based on the number of cameras that have not been processed in S1302 from the maximum number of image windows set in S1201 and the list of network cameras output in S1203. The processing unit 302 prepares a new layout from the read template and sets this layout as the layout at the placement destination (S1305).

The processing unit 302 places the target network camera in a non-placed region of the layout at the placement destination (S1306).

After the repetition of S1303 to S1306, the processing unit 302 adds the layout to the layout sequence to be updated in association with the layout information already placed and the display time set in S1201 (S1307).

When the number of network cameras placed does not reach the number up to which placement is possible in the layout template, the processing unit 302 may delete the information of the non-placed region.

Also, the layout sequence to be updated may not be set in S1201, but the processing unit 302 may prepare a new layout sequence to be updated with a selected network camera using the processing in FIGS. 12 and 13.

According to this embodiment, a network camera that has not been used for display in the existing layout can be used in a newly added layout. Thus, more network cameras can be used effectively.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-097113, filed May 8, 2014 which is hereby incorporated by reference herein in its entirety.

What is claimed is:

1. A management apparatus for managing a plurality of network cameras, comprising:
a receiving unit configured to receive, via a communication network, images shot by a plurality of network cameras; and
a control unit configured to control to display, in accordance with first information representing network cameras to be managed and second information representing network cameras which shoot images to be displayed on a display unit, third information of at least one managed network camera which is not included in the network cameras represented by the second information.

2. An apparatus according to claim 1, wherein the second information represents display layout of images and the network cameras which shoot the images to be displayed according to the display layout.

3. An apparatus according to claim 1, wherein the second information represents a plurality of display layouts of images and the network cameras which shoot the images to be displayed according to the plurality of display layouts.

4. An apparatus according to claim 1, wherein the control unit is configured to determine managed network cameras which are not included in the network cameras represented by the second information, and to determine display layout of the images shot by the determined network cameras.

5. A management apparatus for managing a plurality of network cameras, comprising:
a receiving unit configured to receive, via a communication network, video shot by a plurality of network cameras; and
a control unit configured to control to display, in accordance with information representing network cameras which shoot video to be displayed in accordance with a plurality of display layouts, information based on a number of times the video shot by the network cameras are displayed or a time of period for which the video shot by the network cameras are displayed.

6. An apparatus according to claim 5, wherein the control unit is configured to control to display, in accordance with the information representing the plurality of display layouts including display seizes of the video displayed according to the plurality of display layouts, the information based on the time of period and display sizes of the video shot by the network cameras.

7. An apparatus according to claim 5, wherein the control unit is configured to control to display, in accordance with the information, the information based on values set for shooting the video and based on the number of times the video shot by the network cameras are displayed or the time of period for which the video shot by the network cameras are displayed.

8. A method for managing a plurality of network cameras, comprising:
receiving, via a communication network, images shot by a plurality of network cameras; and
controlling to display, in accordance with first information representing network cameras to be managed and second information representing network cameras which shoot images to be displayed on a display unit, third information of at least one managed network camera which is not included in the network cameras represented by the second information.

9. A method according to claim 8, wherein the second information represents display layout of images and the network cameras which shoot the images to be displayed according to the display layout.

10. A method according to claim 8, wherein the second information represents a plurality of display layouts of images and the network cameras which shoot the images to be displayed according to the plurality of display layouts.

11. A method according to claim 8, wherein the controlling step determines managed network cameras which are not included in the network cameras represented by the second information, and determines display layout of the images shot by the determined network cameras.

12. A method for managing a plurality of network cameras, comprising:
receiving, via a communication network, video shot by a plurality of network cameras; and
controlling to display, in accordance with information representing network cameras which shoot video to be displayed in accordance with a plurality of display layouts, information based on a number of times the video shot by the network cameras are displayed or a time of period for which the video shot by the network cameras are displayed.

13. A method according to claim 12, wherein the controlling step controls to display, in accordance with the information representing the plurality of display layouts including display seizes of the video displayed according to the plurality of display layouts, the information based on the time of period and display sizes of the video shot by the network cameras.

14. A method according to claim 12, wherein the controlling step controls to display, in accordance with the information, the information based on values set for shooting the video and based on the number of times the video shot by the network cameras are displayed or the time of period for which the video shot by the network cameras are displayed.

15. A storage medium for storing a computer program, the computer program comprising:
receiving, via a communication network, images shot by a plurality of network cameras; and
controlling to display, in accordance with first information representing network cameras to be managed and second information representing network cameras which shoot images to be displayed on a display unit, third information of at least one managed network camera which is not included in the network cameras represented by the second information.

16. A storage medium according to claim 15, wherein the second information represents display layout of images and the network cameras which shoot the images to be displayed according to the display layout.

17. A storage medium according to claim 15, wherein the second information represents a plurality of display layouts of images and the network cameras which shoot the images to be displayed according to the plurality of display layouts.

18. A storage medium according to claim 15, wherein the controlling step determines managed network cameras which are not included in the network cameras represented by the second information, and determines display layout of the images shot by the determined network cameras.

19. A storage medium for storing a computer program, the computer program comprising:
receiving, via a communication network, video shot by a plurality of network cameras; and
controlling to display, in accordance with information representing network cameras which shoot video to be displayed in accordance with a plurality of display layouts, information based on a number of times the video shot by the network cameras are displayed or a time of period for which the video shot by the network cameras are displayed.

20. A storage medium according to claim 19, wherein the controlling step controls to display, in accordance with the information representing the plurality of display layouts including display seizes of the video displayed according to the plurality of display layouts, the information based on the time of period and display sizes of the video shot by the network cameras.
